(19) United States
(12) Patent Application Publication
(10) Pub. No.: US 2026/0172762 A1
(43) Pub. Date: Jun. 18, 2026

(54) HEARING DEVICE WITH SYMMETRIC MICROPHONE INLET

(71) Applicant: GN Hearing A/S, Ballerup (DK)

(72) Inventor: Yu LUAN, Kongens Lyngby (DK)

(73) Assignee: GN Hearing A/S, Ballerup (DK)

(21) Appl. No.: 19/405,438

(22) Filed: Dec. 2, 2025

(30) Foreign Application Priority Data
Dec. 13, 2024 (EP) 24219938

(51) Int. Cl. H04R 25/00; H04R 1/08

(52) U.S. Cl. CPC H04R 25/456; H04R 1/083; H04R 25/402; H04R 25/405; H04R 25/65; H04R 2225/021

(57) ABSTRACT

A hearing device is disclosed. The hearing device comprises a housing. The hearing device comprises a microphone having a microphone inlet. The hearing device comprises a microphone inlet structure forming an inlet path from a first inlet to a second inlet, the first inlet facing a first direction and the second inlet facing a second direction different from the first direction, the inlet path comprising a first inlet path from the first inlet to the microphone inlet, and a second inlet path from the second inlet to the microphone inlet. The first inlet path comprises a first primary portion having a first primary center axis through the first inlet, the second inlet path comprises a second primary portion having a second primary center axis through the second inlet, wherein the first primary center axis and the second primary center axis are different.

### RELATED APPLICATION DATA

This application claims priority to, and the benefit of, European Patent Application No. 24219938 filed on Dec. 13, 2024. The entire disclosure of the above application is expressly incorporated by reference herein.

### FIELD

The present disclosure relates to a hearing device and in particular to hearing devices with improved pick-up of sound.

### BACKGROUND

Hearing devices are becoming increasingly compact which brings new challenges in improving performance. The small size of hearing devices, in combination with hearing device movement leads to an increased feedback gain, due to build-up sound pressure at the microphone inlet, for most types of hearing devices e.g., Behind-the-ear, BTE, hearing devices and Receiver-in-ear, RIE, hearing devices.

### SUMMARY

Accordingly, there is a need for a hearing device designed to reduce feedback gain at the microphone inlet.

A hearing device is disclosed, the hearing device comprises a housing, a microphone having a microphone inlet, and a microphone inlet structure. The microphone inlet structure forms an inlet path, e.g. from a first inlet to a second inlet, the first inlet facing a first direction, and the second inlet facing a second direction optionally different from the first direction. The inlet path comprises one or more inlet paths including a first inlet path, e.g. from the first inlet to the microphone inlet, and optionally a second inlet path, e.g. from the second inlet to the microphone inlet or a second microphone inlet. The first inlet path comprises a first primary portion having a first primary center axis, e.g. through the first inlet. The second inlet path comprises a second primary portion having a second primary center axis, e.g. through the second inlet, wherein the first primary center axis and the second primary center axis may be different.

It is an important advantage of the present disclosure that improved sound pick-up is provided by a reduction in pick-up or detection of unwanted sounds.

The disclosed hearing device with a symmetric inlet structure advantageously reduces the build-up pressure at the microphone inlet, e.g. when the hearing device moves and/or vibrates during use, which in turn improves the quality of the signal which is picked up by the microphone.

Further, the disclosed hearing device reduces the noise in the total feedback gain, e.g. caused by movement and/or acceleration, by releasing the build-up pressure at the microphone inlet, and can advantageously be applied to all types of microphone-based hearing devices.

### BRIEF DESCRIPTION OF DRAWINGS

The above and other features and advantages of the present disclosure will become readily apparent to those skilled in the art by the following detailed description of exemplary embodiments thereof with reference to the attached drawings, in which:

FIG. 1 illustrates an example hearing device according to the disclosure,

FIG. 2 schematically illustrates an example hearing device with a housing and a microphone inlet structure according to the disclosure,

FIGS. 3-5 schematically illustrate an example microphone inlet structure and microphone according to the disclosure,

FIG. 6 shows a second inlet view of an example microphone inlet structure according to the disclosure,

FIG. 7 shows a top view of an example microphone inlet structure according to the disclosure,

FIGS. 8-10 illustrate examples of Finite Element Analysis (FEA) simulations of build-up pressure in a centrosymmetric microphone inlet structure,

FIGS. 11-12 schematically illustrate the build-up pressure in a centrosymmetric microphone inlet structure,

FIG. 13 illustrates the phase and sound pressure level of build-up pressure in a centrosymmetric microphone inlet structure, and

FIG. 14 schematically shows a dual-microphone hearing device with centrosymmetric inlets, according to the disclosure.

### DETAILED DESCRIPTION

Various exemplary embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user and may be a hearable or a hearing aid, wherein the processor is configured to compensate for a hearing loss of a user.

The hearing device may be of the behind-the-ear (BTE) type, in-the-ear (ITE) type, in-the-canal (ITC) type, receiver-in-canal (RIC) type, receiver-in-the-ear (RITE) type or microphone-and-receiver-in-the-ear (MaRIE) type. The hearing device may be a binaural hearing device in a binaural hearing system.

The hearing device may comprise a first earpiece and a second earpiece, wherein the first earpiece and/or the second earpiece is an earpiece as disclosed herein.

A hearing device and related method is disclosed, the hearing device comprising a hearing device module and a battery module, the hearing device module comprising a housing forming at least a part of an outer surface of the hearing device. The housing may comprise one or more shell parts or outer parts.

The hearing device module comprises a frame arranged in the housing. The frame may be configured to carry a printed circuit board, PCB, such as flexible PCB. In other words, the PCB or PCBA of the hearing device module also denoted first PCB may be mounted on the frame. One or more electric components of the hearing device, such as one or more of processor, radio transceiver, power module, and microphone(s) may be mounted on the PCB, e.g. for forming a PCBA. In one or more examples, the housing, such as one or more shell parts of the housing, may be mounted on the frame.

The hearing device comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal. The set of microphones may include one or more of a directional microphone and an omnidirectional microphone.

The set of microphones may comprise back-to-back dual microphones. The back-to-back dual microphones may comprise a first microphone inlet and a second microphone inlet, wherein the first microphone inlet and the microphone dual inlet are separate from each other. The microphone inlet structure may comprise a first inlet path from the first inlet in the housing to the first microphone inlet. The microphone inlet structure may comprise a second inlet path from the second inlet in the housing to the second microphone inlet. The microphone inlet structure may be arranged so the first inlet path is configured to translate into the second inlet path, e.g. by a rotation about a rotation axis.

The terms ‘sound signal input’ and ‘sound wave’ are used interchangeably throughout this disclosure.

A hearing device is disclosed. The hearing device comprises a housing.

A housing may be associated with the outer structure of an electronic device, for example a hearing device. A housing may be seen as a structure accommodating or encasing other parts of the hearing device. For example, in a hearing device a housing may be seen as a scaffold that may provide mounting slots for other components. The housing may be a multi-part housing, e.g. comprising one or more shell parts.

The hearing device comprises a microphone having a microphone inlet. A microphone may be seen as a device for obtaining a sound signal input. A microphone may be connected to other electronic circuitry. The microphone may provide a sound signal input to the other electronic circuitry. The other electronic circuitry may be configured to process and/or transmit the sound signal input. A microphone could for example comprise a diaphragm and/or a membrane. The diaphragm and/or membrane may be coupled to a microphone electronic circuit to obtain a sound signal input from vibrations, e.g. a sound wave. A microphone may constitute part of a hearing device to obtain a sound signal input for a user. A microphone inlet may be seen as an opening in a surface of the microphone or microphone housing. In other words, a microphone inlet may allow for e.g. a sound wave to provide at stronger and/or clearer sound signal input to a diaphragm and/or a membrane of the microphone.

The hearing device comprises a microphone inlet structure.

A microphone inlet structure may be seen as a structure associated with one or more microphones, when the microphone is incorporated in another structure. For example, a microphone inlet structure may comprise or form an inlet path for an external stimulus, such as a sound wave, to arrive at a microphone inlet of a microphone. An external stimulus may comprise one or more of: a pressure sound wave traveling through a liquid medium, a gaseous medium, and a solid medium. In other words, a microphone inlet structure may provide access for one or more microphones to obtain a signal from an external stimulus or the surroundings.

The microphone inlet structure comprises or forms one or more inlet paths. An inlet path may be from a first inlet to a second inlet. The first inlet may be arranged in the housing and/or the second inlet may be arranged in the housing. An inlet path comprises a first inlet path and/or a second inlet path. The first inlet path may be from the first inlet to a (first) microphone inlet of a (first) microphone. The second inlet path may be from the second inlet to the (first) microphone inlet or from the second inlet to a second microphone inlet of a second microphone.

An inlet (such as a first inlet, a second inlet) may be seen as an opening in a surface providing access for an external stimulus. For example, an inlet may be seen as an opening that may provide access for an external stimulus in a certain direction, e.g. towards a microphone inlet structure. An external stimulus may for example be a sound wave. In other words, an inlet may for example be an opening in a surface of a hearing device housing leading to the microphone inlet structure/inlet path.

An inlet path, such as a first inlet path and/or a second inlet path, may be seen as a part of an inlet structure, for example an inlet path may be seen as part of a microphone inlet structure. An inlet path may be associated with the internal volume of a microphone inlet structure for example between a first inlet and a (first) microphone inlet, a second inlet and a (first) microphone inlet, a second inlet and a second microphone inlet, and/or a first inlet and a second inlet. An inlet path may be seen as a guide, such as an internal guide, for an external stimulus, e.g. a sound signal input, towards a microphone inlet. In other words, an inlet path may for example provide a stronger and/or clearer sound signal input at a microphone and/or a microphone inlet.

An inlet path, such as a first inlet path and/or a second inlet path, may have a circular or oval cross-section. An inlet path, such as a first inlet path and/or a second inlet path, may have a cross-sectional area in the range from 0.5 mm² to 3 mm².

The hearing device comprises the first inlet facing a first direction and the second inlet facing a second direction different from the first direction, the inlet path comprising a first inlet path from the first inlet to the microphone inlet, and a second inlet path from the second inlet to the microphone inlet.

The first inlet path comprises a first primary portion having a first primary center axis through the first inlet.

An inlet path, such as first inlet path and/or second inlet path, may be seen as a path leading to a microphone inlet. An inlet path may be seen as a structure that aims to provide an improved signal, e.g. a sound signal input, at an inlet. An inlet path may for example provide a sound signal input for a microphone inlet as described herein.

A portion (such as a first primary portion, a second primary portion, a first secondary portion, a second secondary portion, a first intermediate portion, a second intermediate portion) of, e.g. a path, may be associated with a smaller part of a larger structure. For example, a portion may be seen as a distinct part of a longer path, such as an inlet path for a microphone inlet. An inlet path, e.g. an inlet path for a microphone inlet, may comprise one or more portions.

A center axis, such as a first primary center axis, a second primary center axis, a first secondary center axis, a second secondary center axis, a first intermediate center axis, a second intermediate center axis, may be seen as an axis associated with a portion of an inlet path. For example, a center axis may be indicative of an axis associated with the center part of a structure. In other words, a center axis may be seen as an axis spanning the length of a structure while being substantially equidistant from the structure on opposite sides.

The second inlet path comprises a second primary portion having a second primary center axis through the second inlet, optionally wherein the first primary center axis and the second primary center axis are different.

In one or more examples, a hearing device is disclosed, the hearing device comprising a housing; a microphone having a microphone inlet; and a microphone inlet structure forming an inlet path from a first inlet to a second inlet, the first inlet facing a first direction and the second inlet facing a second direction different from the first direction, the inlet path comprising a first inlet path from the first inlet to the microphone inlet, and a second inlet path from the second inlet to the microphone inlet, the first inlet path comprising a first primary portion having a first primary center axis through the first inlet, the second inlet path comprising a second primary portion having a second primary center axis through the second inlet, wherein the first primary center axis and the second primary center axis are different.

The present disclosure advantageously enables the hearing device to obtain a sound signal input with reduced feedback signal. The signal obtained by a microphone and/or set of microphones in a hearing device, Vₜₒₜ, can be calculated using Equation 1:

$${V}_{tot} = {V}_{aco} + {V}_{vib} + {V}_{inlet} \qquad ( 1 )$$

Where V_{aco} is the acoustic voltage output due to the sound pressure at the microphone inlet opening, V_{vib} is induced by the microphone body vibration, and Vᵢₙₗₑₜ is related to the pressure build-up in the microphone inlet. To improve the signal received by the microphone it would be advantageous to reduce Vᵢₙₗₑₜ. The build-up pressure Vᵢₙₗₑₜ increases due to hearing device vibration. The air particles in the inlet are affected by inertia as the microphone body vibrates.

For example, when the hearing device accelerates in a direction, the air molecules are compressed in the opposite direction. The air compression may result in an increased air pressure at the microphone, or the air compression may result in a decreased air pressure at the microphone. The changing air pressure at microphone may affect the membrane and/or diaphragm, which may result in an increased feedback signal. The change in air pressure, p, may be calculated using Equation 2:

$$p = {ρ}_{0} la \qquad ( 2 )$$

Where ρ₀ is the air density, l is the length of the inlet, and a is the acceleration on the system. The present disclosure may advantageously increase the stability of the hearing device and provide an increased gain. The increased stability is enabled by applying a symmetric and/or centrosymmetric microphone inlet structure, where the inlets are oriented in different directions. The centrosymmetric microphone inlet structure will enable the build-up pressure to be cancelled as an equal build-up pressure in antiphase is provided in the two symmetric parts. From Equation 2 it may be appreciated that the increased pressure p is likely to be similar but with opposite sign for each symmetric inlet path, which may enable the build-up pressure in one inlet path to negate the build-up pressure in the other inlet path. It may be appreciated from Equation 2 that build-up pressure is neglectable in directions that does not have an inlet.

In one or more example hearing devices, the first primary center axis and the second primary center axis are parallel and optionally having a distance larger than 0.5 mm. In one or more examples, the distance may be larger than 0.6 mm, such as in the range from 0.6 mm to 20 mm, such as 0.6 mm to 12 mm. In one or more examples, the distance is 1.0 mm, 2.0 mm, 3.0 mm, 4.0 mm, 5.0 mm, 6.0 mm, 7.0 mm, 8.0 mm, 9.0 mm, or 10.0 mm, or any ranges therebetween.

In one or more example hearing devices, the first inlet path comprises a first secondary portion having a first secondary center axis. The first secondary center axis may be different from the first primary center axis. In one or more example hearing devices the first secondary center axis may be parallel to the first primary center axis. For example, the distance between the first primary center axis and the first secondary center axis may be larger than 0.2 mm, such as larger than 0.5 mm or larger than 1.0 mm.

In one or more example hearing devices, the first secondary center axis is parallel to a plane comprising the microphone inlet. The microphone inlet may comprise an opening in a microphone or a microphone housing. The microphone or microphone housing may be arranged so that the plane spanned by the microphone inlet is parallel to the first secondary center axis. In other words, the microphone inlet may be placed symmetrically with regards to the first secondary center axis.

In one or more example hearing devices, the first inlet path comprises a first primary bend between the first primary portion and the microphone inlet. A bend, such as one or more of a first primary bend, a second primary bend, a first secondary bend, and a second secondary bend, may be seen as a part of a microphone inlet structure/inlet path where the center axis changes direction. A bend may be associated with an amount of degrees of difference in direction for a center axis.

In one or more example hearing devices, the first inlet path comprises a first secondary bend between the first primary bend and the microphone inlet. The first primary bend and the second primary bend may be seen as a first intermediate portion of the first inlet path. In other words, the first inlet path may comprise a first intermediate portion, e.g. between the first primary portion and the second primary portion. The first intermediate portion may fluidly connect e.g. the first primary portion and the second primary portion. The first intermediate portion may have a first intermediate center axis. The first intermediate center axis may be different from one or more of: the first primary center axis and the second primary center axis. The first intermediate center axis may intersect the first primary center axis. The smallest angle between the first intermediate center axis and the first primary center axis may be in the range from 20 deg and 90 deg, such as in the range from 30 deg to 80 deg, or in the range from 40 deg to 80 deg, or in the range from deg to 75 deg. The first intermediate center axis may intersect the second primary center axis. The acute angle between the first intermediate center axis and the second primary center axis may be in the range from 0 to 20 deg, such as in the range from 30 deg to 80 deg, or in the range from 40 deg to 80 deg, or in the range from 45 deg to 75 deg.

In one or more example hearing devices, the first inlet path is configured to translate into the second inlet path, e.g. by a rotation about a rotation axis.

A rotation axis may be seen as a 1-dimensional object. A rotation axis may be associated with a line in space. A rotation axis may be associated with an object being rotated about the rotation axis, the object being translated into a new set of coordinates. A rotation axis may comprise an axis intersecting an object to be rotated. A rotation about a rotation axis may translate a part of an object into an identical part of the object, as disclosed herein. An object to rotate about a rotation axis may for example comprise a microphone inlet structure.

In one or more example hearing devices, the rotation axis is perpendicular to a primary plane spanned by the first primary center axis and the second primary center axis.

In one or more example hearing devices, the microphone inlet structure is centrosymmetric.

In one or more example hearing devices, the microphone inlet is arranged in proximity of, at, adjacent to or within a small distance of a centrosymmetric inversion point of the microphone inlet structure. For example, the microphone inlet, such as the center of microphone inlet, may be arranged within 3 mm, such as within 2 mm or within 1 mm, from a centrosymmetric inversion point of the microphone inlet structure.

Centrosymmetric may be seen as a term indicative of a certain structure. Symmetric broadly refers to a structure associated with a symmetry operation, e.g. about centrosymmetric inversion point. A symmetry operation may be seen as a mathematically described operation associated with translating a part of a structure into another identical part of the structure. Symmetry operations may comprise one or more of: reflection in a plane, rotation about an axis, inversion around a point. A centrosymmetric object is indicative of an object that has inversion symmetry around an inversion center. Inversion symmetry around an inversion center may be seen as an object having a feature at a coordinate (x, y, z) also comprises an identical feature at a coordinate (−x, −y, −z), e.g. where (0,0,0) is the centrosymmetric inversion point. This inversion symmetry being present for all coordinates of the object. For example, a microphone inlet structure may be translated such that a first inlet is translated into a second inlet by inversion symmetry. For example, a microphone inlet structure may be translated such that a first inlet path is translated into a second inlet path by inversion symmetry.

In one or more example hearing devices, a first length of the first inlet path from the first inlet to the microphone inlet, such as microphone inlet center, is less than 10 mm, such as in the range from 2 mm to 9 mm. The first length of the first inlet path from the first inlet to the microphone inlet, such as microphone inlet center, may be equal to a second length of the second inlet path from the second inlet to the microphone inlet, such as microphone inlet center. A difference between the first length and the second length may be less than 2 mm, such as less than 1 mm.

In one or more example hearing devices, an inlet housing distance between the first inlet and the second inlet along the housing is less than 20 mm, such as in the range from 5 mm to 19 mm.

An inlet housing distance may be associated with a distance between one or more inlets in another structure, e.g. a housing. A housing may be associated with e.g. a hearing device housing as disclosed herein. An inlet housing distance may be seen as a distance between one or more inlets and/or openings, along the outer side of a housing. An inlet housing distance may be the shortest distance between one or more inlets along the outer shell of a hearing device housing. In other words, an inlet housing distance may be the shortest distance between the first inlet and the second inlet on the outer surface of the housing of a hearing device.

It is noted that descriptions and features of hearing device functionality, such as hearing device configured to relieve build-up pressure, also apply to methods and vice versa. For example, a description of a hearing device configured to determine also applies to a method, e.g. of operating a hearing device, wherein the method comprises determining and vice versa.

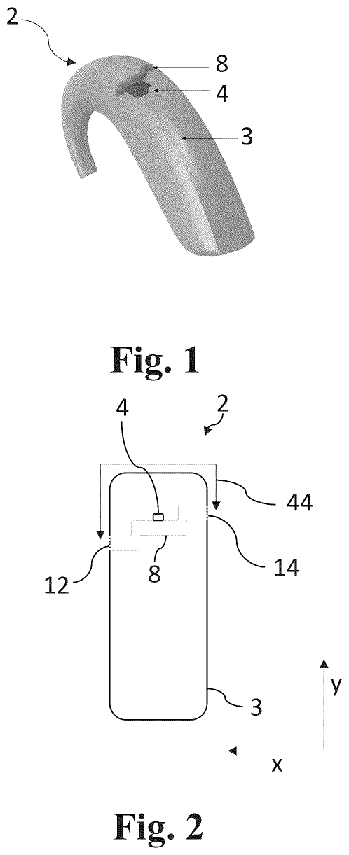

FIG. 1 shows an example of a hearing device 2 according to the disclosure. The hearing device comprises a housing 3, a microphone 4, and a microphone inlet structure 8. The microphone inlet structure 8 comprises a first inlet and a second inlet in the housing 3. In other words, the housing 3 is configured so that microphone inlet structure 8 has access to one or more openings in the one or more shell parts of the housing.

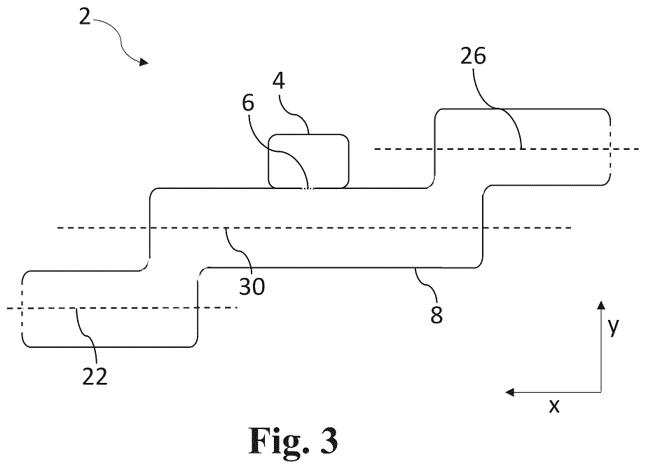

FIG. 2 illustrates a schematic cross-section of hearing device 2 with a microphone inlet structure 8 according to the disclosure. The hearing device 2 comprises a housing 3, and a microphone 4 comprising a microphone inlet structure 8. The hearing device 2/microphone inlet structure 8 comprises at least a first inlet 12 and a second inlet 14 in the housing 3, optionally at either end of the microphone inlet structure 8. The distance from the first inlet 12 to the second inlet 14, measured as the shortest distance along the outer part of the housing 3, may be referred to as an inlet housing distance 44.

In one or more example hearing devices 2, the microphone inlet structure 8 may form an inlet path from the first inlet 12 to the second inlet 14.

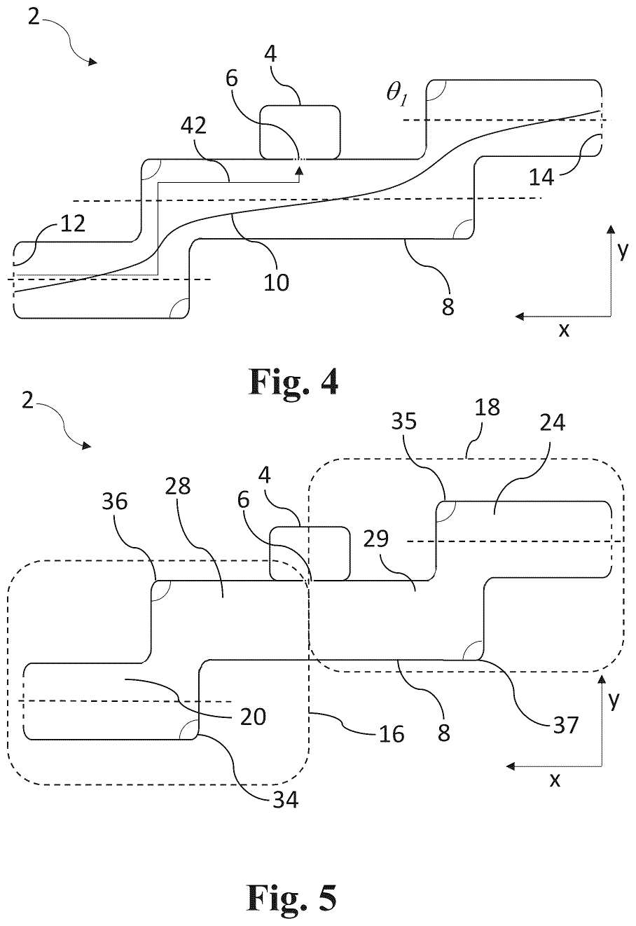

FIGS. 3-5 schematically illustrate an example microphone inlet structure 8 and a microphone 4 comprising a microphone inlet 6 according to the disclosure.

FIG. 3 illustrates schematically a cross-section of a microphone inlet structure 8 and a microphone 4 comprising a microphone inlet 6, according to the disclosure. For example, the microphone inlet 6 may fluidly connect the microphone 4 and the microphone inlet structure 8.

FIG. 3 shows and example of a first primary center axis 22 and a second primary center axis 26. The hearing device 2 may be configured such that the first primary center axis 22 and the second primary center axis 26 are parallel. The first primary center axis 22 may intersect the first inlet 12 (shown in FIG. 2). The second primary center axis 26 may intersect the second inlet 14 (shown in FIG. 2). FIG. 3 shows an example of a first secondary center axis 30. The hearing device 2 may comprise a first secondary center axis 30 that may be parallel to the first primary center axis 22. In some example hearing devices, the first secondary center axis 30 may not be parallel to the first primary center axis, e.g. forming an angle larger than 45 degrees. In one or more examples hearing devices, the first primary center axis 22 and the first secondary center axis 30 are parallel and different, e.g. having a distance therebetween. The axes 22, 30 may be non-intersecting.

FIG. 4 illustrates schematically a cross-section of a microphone inlet structure 8 and a microphone 4 comprising a microphone inlet 6, according to the disclosure. FIG. 4 schematically shows a first inlet 12 and a second inlet 14. The hearing device 2 may comprise the microphone inlet structure to provide an inlet path 10 from the first inlet 12 to the second inlet 14. Fig. shows a first length 42 comprising the inlet path through the microphone inlet structure 8 from the first inlet 12 to the microphone inlet 6.

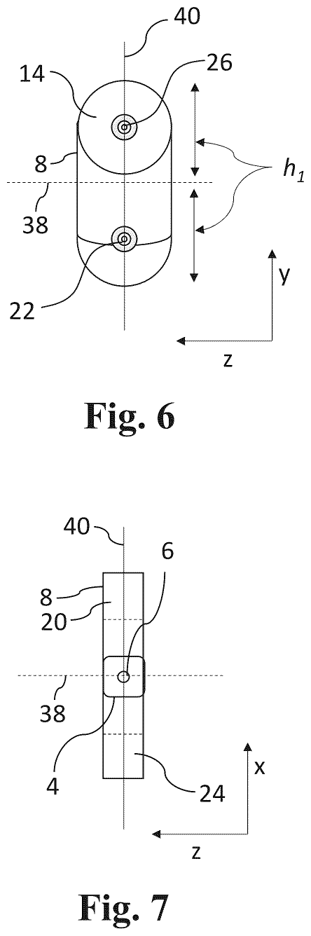

FIG. 5 illustrates schematically a cross-section of a microphone inlet structure 8 and a microphone 4 comprising a microphone inlet 6, according to the disclosure. FIG. 5 schematically illustrates a first inlet path 16 and a second inlet path 18. The first inlet path comprises a first primary portion 20, a first primary bend 34, a first secondary bend 36, and a first secondary portion 28. The hearing device 2 may be configured to enable the angle of the first primary bend 34 and the angle of the first secondary bend 36 to be the same. The second inlet path 18 comprises a second primary portion 24, a second primary bend 35, a second secondary bend 37, and a second secondary portion 29. In some examples the first inlet path 16 may be translated into the second inlet path 18, by a rotation about an axis, see FIG. 6. As illustrated in microphone inlet structure 8, the microphone inlet structure 8 may be centrosymmetric.

FIG. 6 schematically illustrates a second inlet view of a microphone inlet structure 8 according to the disclosure. FIG. 6 shows an example of the first primary center axis 22 and the second primary center axis. A primary plane 40 is spanned by the first primary center axis 22 and the second primary center axis 26. A rotation axis 38 may be seen, for example the rotation axis may be one or more of a distance h1 from the top of the microphone inlet structure 8 and a distance h1 from the bottom of the microphone inlet structure 8. The rotation axis 38 may be perpendicular to the primary plane 40 spanned by the first primary center axis 22 and the second primary center axis 26. In one or more example hearing devices, the rotation axis 38 is parallel to the plane spanning the microphone inlet 6 and perpendicular to the primary plane 40. In other words, the rotation axis 38 may enable the first inlet path 16 to translate into the second inlet path 18 by symmetric rotation about an axis at the microphone inlet 6.

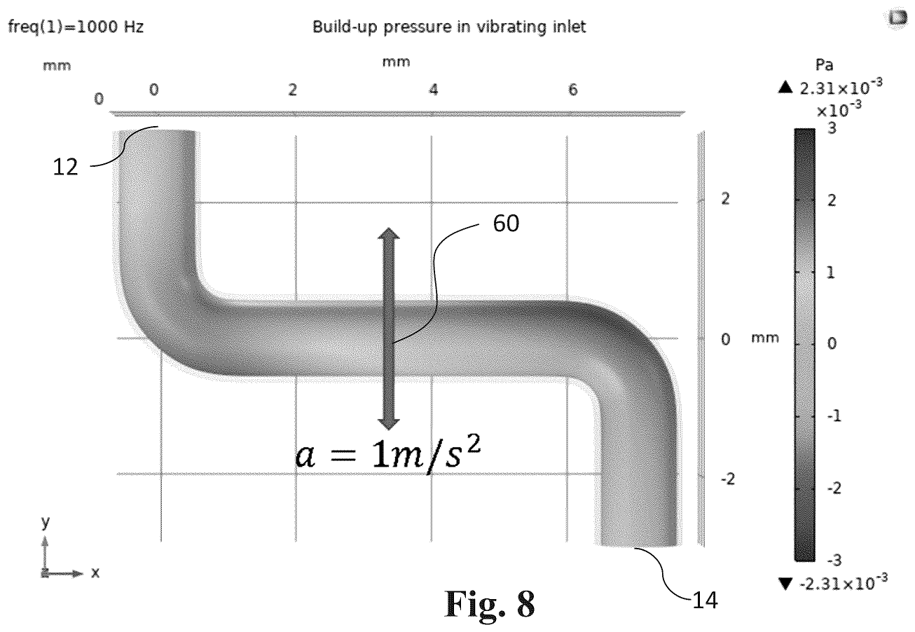

FIG. 7 schematically illustrates a top view of a microphone inlet structure 8 and a microphone 4 comprising a microphone inlet 6, according to the disclosure. The regions comprising the first primary portion 20 and the second primary portion 24 are indicated. A top view of the primary plane 40 is indicated. A rotation axis 38 is indicated, the rotation axis may be perpendicular to the primary plane 40. In other words, the rotation axis may enable the first inlet path 16 to translate into the second inlet path 18 by symmetric rotation about an axis at the microphone inlet 6.

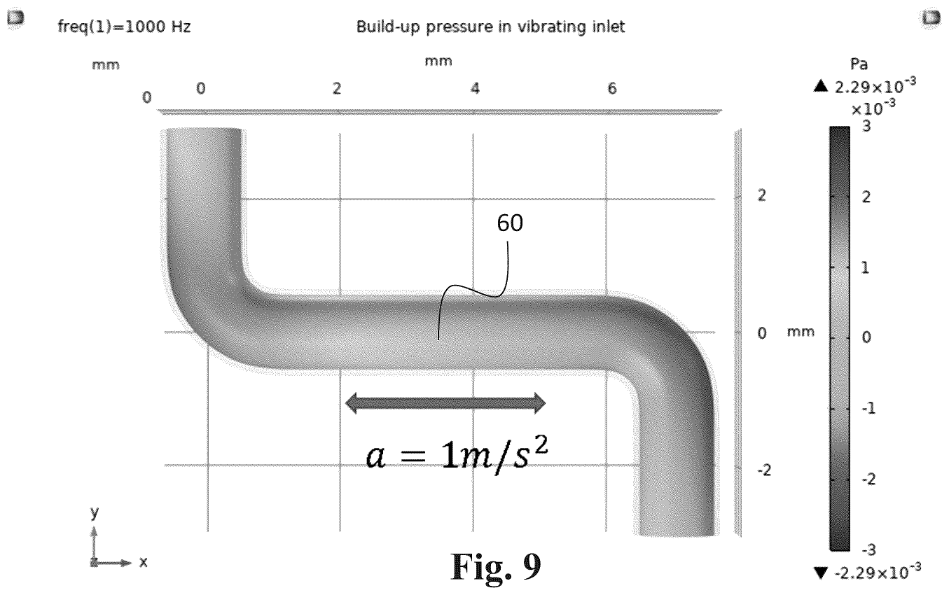

FIG. 8 shows a Finite Element Analysis (FEA) simulation of the build-up pressure difference in an example symmetric microphone inlet structure 8 (shown in FIGS. 1-7), when the microphone inlet structure 8 vibrates along the y-axis with an acceleration of 1 m/s² and a frequency of 1000 Hz. FIG. 8 illustrates that at the centrosymmetric inversion point 60, the build-up pressure difference is cancelled out. In other words, the microphone inlet structure 8 enables the microphone 4 to pick-up improved sound signal input, e.g. by providing the microphone inlet placed in proximity to centrosymmetric inversion point.

FIG. 9 shows a FEA simulation of the build-up pressure difference in an example symmetric microphone inlet structure 8 (shown in FIGS. 1-7), when the microphone inlet structure 8 vibrates along the x-axis with an acceleration of 1 m/s² and a frequency of 1000 Hz. FIG. 9 illustrates that at the centrosymmetric inversion point 60, the build-up pressure difference is cancelled out. In other words, the microphone inlet structure enables the microphone 4 to pick-up improved sound signal input providing the microphone inlet is placed in proximity to centrosymmetric inversion point.

FIG. 10 shows a FEA simulation of the build-up pressure difference in an example symmetric microphone inlet structure 8 (shown in FIGS. 1-7), when the microphone inlet structure vibrates along the x-axis and the y-axis. FIG. 10 illustrates that at the centrosymmetric inversion point 60, the build-up pressure difference is cancelled out. In other words, the microphone inlet structure enables the microphone 4 to pick-up improved sound signal input providing the microphone inlet is placed in proximity to centrosymmetric inversion point.

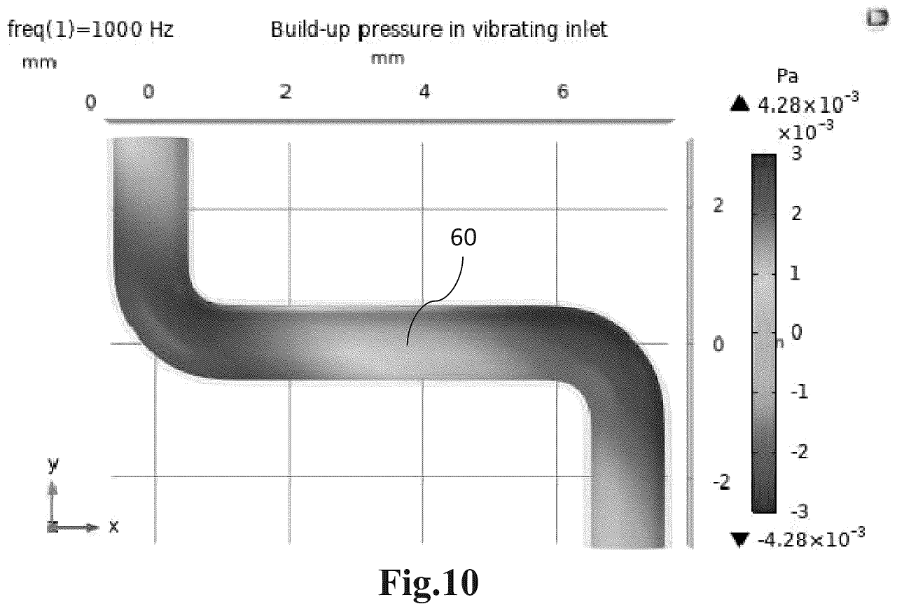

FIG. 11 illustrates schematically the build-up pressure difference in a system comprising a symmetric microphone inlet structure 8, a microphone 4, and a microphone inlet 6. In FIG. 11 the system is accelerated along the direction of the arrow. The centrosymmetric microphone inlet structure allows the air pressure to increase in one region P+ and allows the air pressure to decrease in another region P−. This enables the system to maintain zero build-up pressure at the centrosymmetric inversion point 60 in proximity to microphone inlet 6. The reduced build-up enables the microphone 4 to pick-up an improved sound signal input.

FIG. 12 illustrates schematically the build-up pressure difference in a system comprising a symmetric microphone inlet structure 8, a microphone 4, and a microphone inlet 6. In FIG. 12 the system is accelerated along the direction of the arrow. The centrosymmetric microphone inlet structure allows the air pressure to increase in one region P+ and allows the air pressure to decrease in another region P−. This enables the system to maintain zero build-up pressure at the centrosymmetric inversion point 60 in proximity to microphone inlet 6. The reduced build-up enables the microphone 4 to pick-up an improved sound signal input.

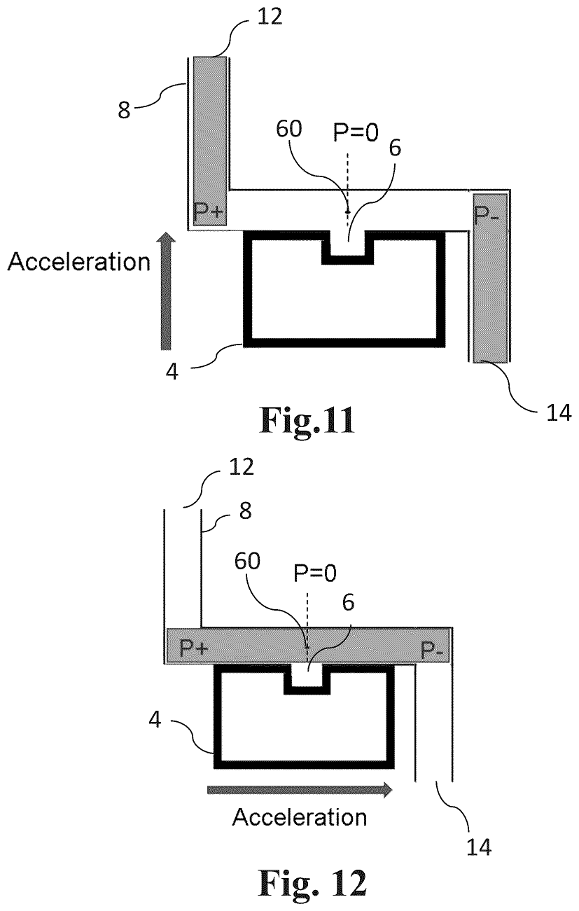

FIG. 13 shows the calculated sound pressure level 50 in dBSPL and the sound phase 52 first secondary portion 28 and the second secondary portion 29 of a centrosymmetric microphone inlet structure during vibration in an arbitrary direction. The plot in FIG. 13 shows the build-up sound pressure level 50 reduced to a negligible level at the same point the sound phase 52 switches 180 deg. A microphone inlet 6 placed at that point would provide an improved sound pick-up.

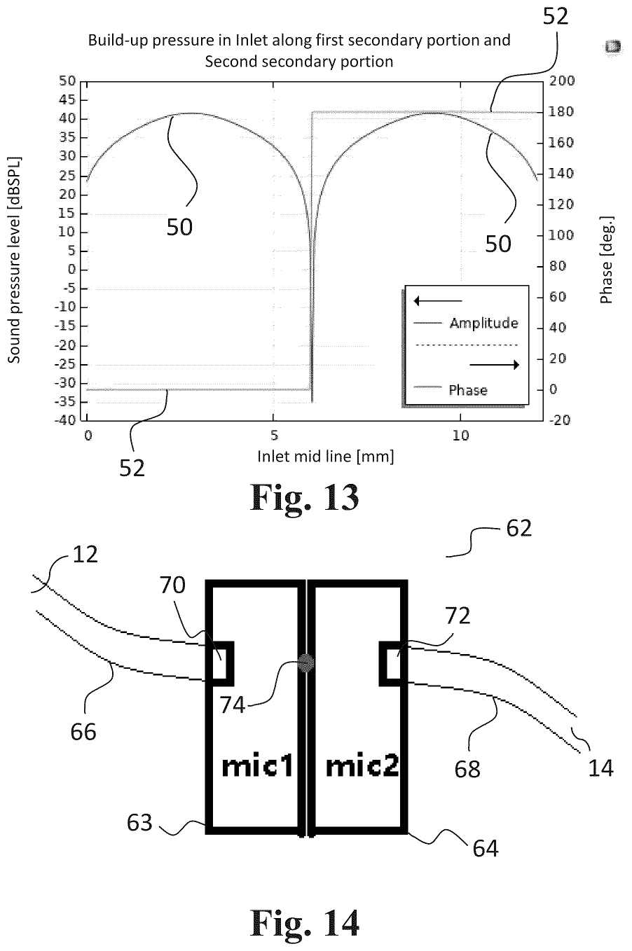

FIG. 14 shows an example of back-to-back dual microphone set 62 comprising a first microphone 63 having a first microphone inlet 70 and a first inlet path 66, a second microphone 64 having a second microphone inlet 72 and a second inlet path 68. The back-to-back dual microphone set 62 is configured to have a centrosymmetric inversion point 74 with regards to the first inlet path 66 and the second inlet path 68.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first or primary element does not imply the presence of a second or secondary element and vice versa.

It may be appreciated that the figures comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

LIST OF REFERENCES

| | |
|---|---|
| 2 | hearing device |
| 3 | housing |
| 4 | microphone |
| 6 | microphone inlet |
| 8 | microphone inlet structure |
| 10 | inlet path |
| 12 | first inlet |
| 14 | second inlet |
| 16 | first inlet path |
| 18 | second inlet path |
| 20 | first primary portion |
| 22 | first primary center axis |
| 24 | second primary portion |
| 26 | second primary center axis |
| 28 | first secondary portion |
| 29 | second secondary portion |
| 30 | first secondary center axis |
| 32 | microphone inlet plane |
| 34 | first primary bend |
| 35 | second primary bend |
| 36 | first secondary bend |
| 37 | second secondary bend |
| 38 | rotation axis |
| 40 | primary plane |
| 42 | first length |
| 44 | inlet housing distance |
| 50 | sound pressure level |
| 52 | sound phase |
| 60 | centrosymmetric inversion point |
| 62 | back-to-back dual microphone set |
| 63 | first microphone |
| 64 | second microphone |
| 66 | first inlet path |
| 68 | second inlet path |
| 70 | first microphone inlet |
| 72 | second microphone inlet |
| 74 | centrosymmetric inversion point |

1. A hearing device comprising:
a housing;
a microphone having a microphone inlet; and
a microphone inlet structure forming an inlet path from a first inlet to a second inlet, the first inlet facing a first direction and the second inlet facing a second direction different from the first direction, the inlet path comprising a first inlet path from the first inlet to the microphone inlet, and a second inlet path from the second inlet to the microphone inlet, the first inlet path comprising a first primary portion having a first primary center axis through the first inlet, the second inlet path comprising a second primary portion having a second primary center axis through the second inlet, wherein the first primary center axis and the second primary center axis are different.

2. The hearing device according to claim 1, wherein the first primary center axis and the second primary center axis are parallel, and wherein a distance between the first primary center axis and the second primary center axis is larger than 0.5 mm.

3. The hearing device according to claim 1, wherein the first inlet path comprises a first secondary portion having a first secondary center axis different from the first primary center axis.

4. The hearing device according to claim 3, wherein the first secondary center axis is parallel to a plane comprising the microphone inlet.

5. The hearing device according to claim 1, wherein the first inlet path comprises a first primary bend between the first primary portion and the microphone inlet.

6. The hearing device according to claim 5, wherein the first inlet path comprises a first secondary bend between the first primary bend and the microphone inlet.

7. The hearing device according to claim 1, wherein a geometry of the second inlet path is the same as a geometry of the first inlet path, and wherein a rotation of the geometry of the first inlet path about a rotation axis will map to the geometry of the second inlet path.

8. The hearing device according to claim 1, wherein the rotation axis is perpendicular to a primary plane defined by the first primary center axis and the second primary center axis.

9. The hearing device according to claim 1, wherein the microphone inlet structure is centrosymmetric.

10. The hearing device according to claim 9, wherein the microphone inlet is within 3 mm from a centrosymmetric inversion point of the microphone inlet structure.

11. The hearing device according to claim 1, wherein a length of the first inlet path from the first inlet to the microphone inlet is less than 10 mm.

12. The hearing device according to claim 1, wherein an inlet housing distance between the first inlet and the second inlet along the housing is less than 20 mm.

13. The hearing device according to claim 1, wherein the first inlet path has a first step configuration, and wherein the second inlet path has a second step configuration.

14. The hearing device according to claim 1, wherein the housing is a behind-the-ear (BTE) housing, and wherein the first primary center axis and the second primary center axis extend through a major side wall of the BTE housing.

15. The hearing device according to claim 1, wherein the microphone inlet structure comprises a first elongated structure, a second elongated structure, and a third elongated structure, wherein the first elongated structure, the second elongated structure, and the third elongated structure form a multi-step configuration.

16. A hearing device comprising:
a housing;
a microphone having a microphone inlet; and
a microphone inlet structure forming an inlet path from a first inlet to a second inlet, the inlet path comprising a first inlet path from the first inlet to the microphone inlet, and a second inlet path from the second inlet to the microphone inlet,
wherein the microphone inlet structure comprises a first elongated structure, a second elongated structure, and a third elongated structure, wherein the first elongated structure, the second elongated structure, and the third elongated structure form a multi-step configuration.

17. The hearing device according to claim 16, wherein the microphone is coupled to the second elongated structure.

18. The hearing device according to claim 16, the first inlet path comprising a first primary portion having a first primary center axis through the first inlet, the second inlet path comprising a second primary portion having a second primary center axis through the second inlet, wherein the first primary center axis and the second primary center axis are different.

19. The hearing device according to claim 18, wherein the first primary center axis and the second primary center axis are parallel, and wherein a distance between the first primary center axis and the second primary center axis is larger than 0.5 mm.

20. The hearing device according to claim 16, wherein the microphone inlet structure is centrosymmetric.

21. The hearing device according to claim 20, wherein the microphone inlet is within 3 mm from a centrosymmetric inversion point of the microphone inlet structure.
